(19) United States
(12) Patent Application Publication
(10) Pub. No.: US 2002/0158137 A1
(43) Pub. Date: Oct. 31, 2002

(54) Systems and methods wherein a machine-readable item code is substantially invisible to a human

(76) Inventors: William Grey, Millwood, NY (US); Paul A. Moskowitz, Yorktown Heights, NY (US); Stephen J. Boies, Mahopac, NY (US); Clifford A. Pickover, Yorktown Heights, NY (US)

Correspondence Address: BUCKLEY, MASCHOFF, TALWALKAR, & ALLISON, 5 ELM STREET, NEW CANAAN, CT, 06840, US

(21) Appl. No.: 09/845,500

(22) Filed: Apr. 30, 2001

(51) Int. Cl. G06K 19/06

(52) U.S. Cl. 235/494

(57) ABSTRACT

Systems and methods are provided wherein a machine-readable item code is substantially invisible to a human. According to one embodiment, a number of machine-readable item codes are printed on an item's surface, at least one item code being (i) associated with the item and (ii) substantially invisible to a human. For example, the item may have item codes printed on different sides of the item. According to some other embodiments, an item code may be associated with a card-holder, updated by a user, and/or contain instructions, such as executable information.

### FIELD

The present invention relates to item codes. In particular, the present invention relates to systems and methods wherein a machine-readable item code is substantially invisible to a human.

### BACKGROUND

It is often necessary to determine or provide information associated with an item. For example, a merchant may need to identify an item being purchased by a consumer. Similarly, a delivery service may need to determine an address associated with a package.

To facilitate such exchanges of information, it is known that visible machine-readable code can be printed on an item. For example, a Universal Product Category (UPC) bar code can be printed on a product's surface (e.g., on the product's label). An employee associated with a merchant can then move the product past a bar code scanner to automatically determine the product's identity (and a price associated with the product). Similarly, the UNITED PARCEL SERVICE OF AMERICA, INC.® prints a matrix code on a label affixed to a package to provide delivery information to employees (e.g., a destination address associated with the package). One such a system is disclosed, for example, in U.S. Pat. No. 5,770,841 entitled “System and Method for Reading Package Information.” The entire content of this patent is incorporated herein by reference.

A number of disadvantages, however, arise when a visible machine-readable code is printed on an item. For example, this approach requires that a portion of the item's surface be devoted to the code. This naturally reduces the area available for other types of information, such as text and graphics describing a product to consumers. Moreover, certain items may not provide enough surface area to include both a visible machine-readable code and other types of information. Further disadvantages include the fact that visible machine-readable codes tend to be unattractive (reducing the appeal of the item to consumers) and that some consumers may attempt to alter a code (e.g., by replacing a UPC code associated with an expensive item with a UPC code associated with an less expensive item).

It is also known that an invisible machine-readable code can be printed on an item's to facilitate an exchange of information. For example, U.S. Pat. No. 6,177,683 entitled “Potable Viewer for Invisible Bar Codes” discloses device that may be used to detect invisible machine-readable codes. The entire content of this patent is incorporated herein by reference. However, when a machine-readable code is invisible it will be difficult for a person to correctly position the code and/or a detecting device that is adapted to read the code. For example, the person may not even known which side of a product contains the code.

Moreover, invisible machine-readable codes have been used with respect to only a limited range of items and a limited range of information associated with those items.

### SUMMARY

To alleviate problems inherent in the prior art, the present invention introduces systems and methods wherein a machine-readable item code is substantially invisible to a human.

One embodiment is directed to an item having an item surface. According to this embodiment, a plurality of machine-readable item codes are printed on the item surface, at least one of the item codes being associated with the item and being substantially invisible to a human.

Another embodiment is directed to an identification card associated with a card-holder. According to this embodiment, a machine-readable code printed on a surface of the identification card, is associated with the card-holder and is substantially invisible to a human.

Another embodiment is directed to a machine-readable item code printed on an item's surface, the item code being associated with the item, substantially invisible to a human, and updated by a user.

Still another embodiment is directed to a machine-readable item code printed on an item's surface, the item code being associated with the item, substantially invisible to a human, and indicating at least one of: (i) information associated with use of the item, (ii) information associated with consumption of the item, (iii) instructions associated with the item, (iv) executable information associated with the item, (v) updates to adjust executable information associated with the item, (vi) instructions associated with assembling of the item, (vii) instructions associated with processing the item, (viii) marketing information, (ix) provenance information, (x) information associated with a sale of the item, (xi) information associated with future disposition of the item, (xii) information associated with disposal of the item, and (xiii) information associated with recycling at least a portion of the item.

Yet another embodiment is directed to a method of marking an item having an item surface. According to this embodiment, an item code associated with the item is determined, and a plurality of machine-readable item codes are printed on the item surface, at least one of the item codes being associated with the item and being substantially invisible to a human.

Another embodiment is directed to an apparatus for marking an item, comprising: (i) a printing controller; and (ii) a printing device in communication with the printing controller and adapted to print a plurality of machine-readable item codes on the item surface, at least one of the item codes being associated with the item and being substantially invisible to a human.

Another embodiment is directed to an apparatus for determining information associated with an item, comprising: (i) a detection controller; and (ii) a detecting device in communication with the detection controller and adapted to read at least one of a plurality of machine-readable item codes on the item surface, at least one of the item codes being associated with the item and being substantially invisible to a human.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram overview of an item according to an embodiment of the present invention.

FIG. 2 is a block diagram overview of a system for printing an item code according to an embodiment of the present invention.

FIG. 3 is a tabular representation of a portion of an item code printing database stored at a printing controller according to an embodiment of the present invention.

FIG. 4 is a flow chart of a method for printing an item code according to an embodiment of the present invention.

FIG. 5 is a block diagram overview of a system for detecting an item code according to an embodiment of the present invention.

FIG. 6 is a tabular representation of a portion of an item code detecting database stored at a detecting controller according to an embodiment of the present invention.

FIG. 7 is a flow chart of a method for detecting an item code according to an embodiment of the present invention.

FIG. 8 is a block diagram overview of an identification card according to another embodiment of the present invention.

### DETAILED DESCRIPTION

Embodiments of the present invention may be associated with systems and methods wherein a machine-readable item “code” is substantially invisible to a human. As used herein, the term “code” refers to any representation of information. A code may be, for example, a bar code representing a product identifier, a matrix code indicating a destination address, or a watermark associated with a manufacturer. A code may also be, for example, alphanumeric information. The term “machine-readable code” refers to any code that can be detected and/or interpreted by a machine (e.g., by a scanning device). The phrase “substantially invisible to a human” refers to anything that is not distracting when viewed by a human. Note that a code that is substantially invisible to a human may be detectable by a human, such as when a person closely examines an item looking for the code. The term “printed” or “printing” refers to any result or method associated with creating a code on a surface. For example, an item code may be printed on an item surface via pressure, chemicals, inks, heat, electricity, or light.

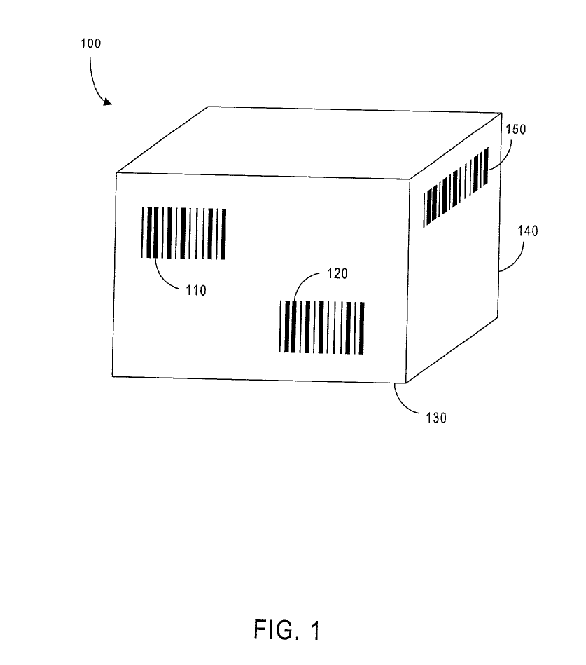

Turning now in detail to the drawings, FIG. 1 illustrates an item 100 according to an embodiment of the present invention. The term “item” may refer to, for example, a product or an object associated with a service (e.g., a receipt or coupon representing an oil change service). Examples of items include automobiles, books, airline tickets, event tickets (e.g., to a sporting or music event) and software programs (e.g., a software program license). The item 100 may also comprise, for example, an identification card, a negotiable instrument (e.g., a bank check or stock certificate), a container (e.g., used to hold one or more products), a tag or label attached to or otherwise associated with a product or package, an envelope, or a document (e.g., a governmental tax return).

As shown,in FIG. 1, the item 100 includes a first item code 110 and a second item code 120 printed on a first side 130 of the item's surface. The item's “surface” may comprise, for example, the actual surface of the item 100 itself, an image, a picture (e.g., a drawing or a photograph), a label (e.g., a sticker affixed to a container), a tag (e.g., a tag attached to a shirt), or a slip (e.g., a piece of paper co-located with the item 100). Although two item codes 110, 120 are shown on the first side 130, more item codes can be included according to the present invention. According to one embodiment, the item 100 has a plurality of distinct item surface areas, such an area associated with the first side 130 and an area associated with a second side 130 of the item 100. In this case, another item code 150 may be printed on the second side 140 of the item 100.

According to the present invention, at least one of the item codes 110, 120 are associated with the item 100. The item codes 110, 120 may represent, for example, an item identifier (e.g., a UPC bar code), a manufacturer identifier, a distributor identifier, a delivery service identifier (e.g., indicating that item 100 is being, or has been, delivered by FEDERAL EXPRESS®), a purchaser identifier, an owner identifier (e.g., indicating who owns the item 100), a user identifier, and/or a merchant identifier (e.g., indicating who sold the item 100).

At least one of the item codes 110, 120 is also substantially invisible to a human (the item codes 110, 120 are visible in FIG. 1 only to facilitate understanding of the invention). For example, both item codes 110, 120 may be rendered substantially invisible by forming them with a chemical, an invisible ink, an ink that becomes visible in ultra-violet light, and/or an ink detectable with radiation outside of the visible spectrum. The item codes may also be rendered substantially invisible by other means (e.g., using micro-printing technology or by slightly altering pre-determined pixels in an image).

By including a plurality of item codes 110, 120 on the item's surface, it may be easier to position the item 100 or a detecting device appropriately. Moreover, because the item code codes are substantially invisible, it may be possible to provide visible information (e.g., text or graphics) on the same area of the item's surface. In addition, it may be more difficult for consumers to attempt to alter the plurality of substantially invisible item codes 110, 120 as compared to visible item codes and/or a single item code.

According to one embodiment, the two item codes 110, 120 contain the same information. For example, the first item code 110 and the second item code 120 may be identical. Note that the two item codes 110, 120 may be formed differently (e.g., one as text and the other as a bar code) and still represent the same information.

According to another embodiment, the two item codes 110, 120 contain different information (e.g., at least a portion of the information is different). The information may be completely independent or may be adapted to be combined, for example, via (i) a sequence number in each item code 110, 120, (ii) information in the first item code 110 indicating how other item codes should be combined, and/or (iii) a position of the item codes 110, 120 on the item surface (e.g., information in an item code located away from the center of the side 130 may be added to information in an item code located near the center of the side 130). According to one embodiment, the first item code 110 contains meta-data associated with the second item code 120 (e.g., the information in the first item code 110 may describe or define the meaning or format of the information in the second item code 120).

According to still another embodiment, the first item code 110 and the second item code 120 are printed on the item 100 via different techniques to render the item codes 110, 120 substantially invisible to a human. Note that this may be the case when the item codes 110, 120 contain either the same information or different information.

According to another embodiment, at least one machine-readable item code is printed on an item's surface, the item code being (i) associated with the item, (ii) substantially invisible to a human, and (iii) updated by a user (e.g., a manufacturer, a distributor, a delivery service, a merchant, a repair service, a government, and/or a consumer). By ways of example, an item code may be removed, added, or adjusted to provide information associated with: a delivery (e.g., to indicate a date, time, and location associated with delivery of the item), a price, a merchant, a purchaser, or an item status (e.g., indicating that the item has been authenticated or reserved by a potential purchaser). Similarly, the item code may be updated to provide information associated with a warranty (e.g., indicating a scope of protection), a product, logistics, a tax (e.g., indicating that a governmental tax associated with the item has been paid by a distributor), a fee, a duty, an inspection, a packing slip, a picking slip (e.g., indicating which items should be “picked” from a distribution center and deposited in a particular container), a bill, an order status, a product expiration (e.g., a “sell by” date associated with the item), a repair or maintenance history, provenance of an item (e.g., indicating an origin or ownership history of an item) and/or restrictions on sale or use of an item (e.g., indicating that an item should not be imported from or exported to a certain region).

According to another embodiment, at least one machine-readable item code is printed on the item's surface, the item code (i) being associated with the item, (ii) being substantially invisible to a human, and (iii) indicating information associated with use or consumption of the item. For example, the item code may be associated with instructions (e.g., medical instructions printed on a prescription drug container to be read by a patient, executable information to be executed by a processor, or updates to a software program). The instructions may also be associated with, for example, how the item should be assembled or processed. According to other embodiments, the item code indicates marketing information (e.g., an advertisement, a coupon, or a proof-of-purchase certificate), provenance information (indicating an origin of the item), information associated with a sale of the item, and/or information associated with a future disposition of the item (e.g., information associated with disposing, reclaiming, or recycling some or all of the item).

Item Code Printing System

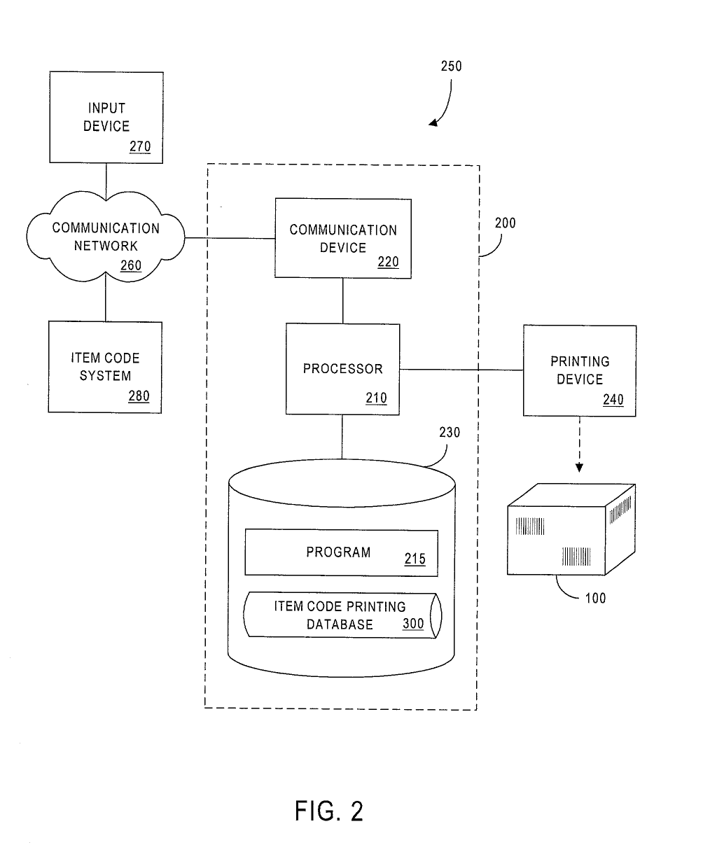

FIG. 2 is a block diagram overview of an item code printing system 250 according to an embodiment of the present invention. The item code printing system 250 includes a printing controller 200 in communication with a printing device 240 adapted to print machine-readable item codes on an item 100. Although a single printing controller 200 and printing device 240 are shown in FIG. 2, any number of these devices may be included in the item code printing system 250. Similarly, any number of the other devices described herein may be included in the item code printing system 250 according to embodiments of the present invention.

The printing controller 200 comprises a processor 210, such as one or more INTEL® Pentium® processors, coupled to a storage device 230. The storage device 230 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

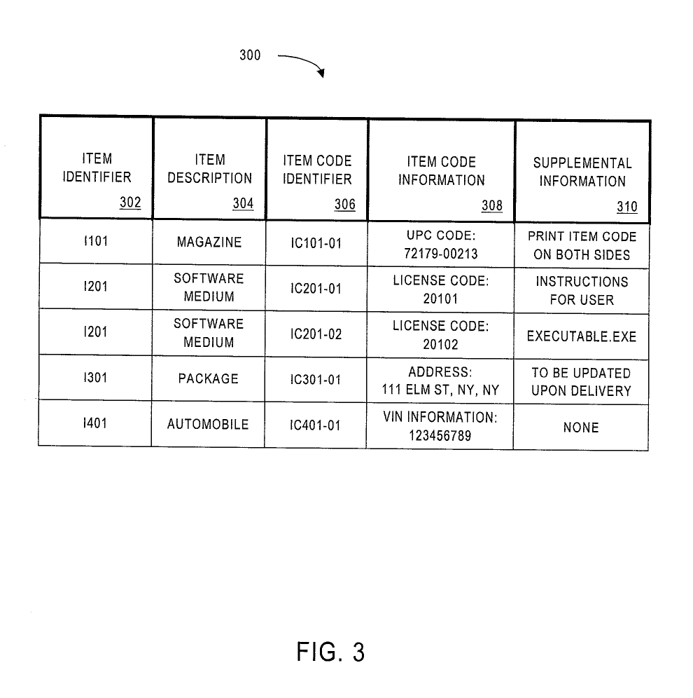

The storage device 230 stores an item code printing database 300. An example of an item code printing database 300 will now be described in detail with respect to FIG. 3. Note that the illustrations and accompanying descriptions of the databases presented herein are exemplary, and any number of other database arrangements could be employed besides those suggested by the figures.

Referring to FIG. 3, a table represents the item code printing database 300 that may be stored at the printing controller 250 according to an embodiment of the present invention. The table includes entries identifying item codes that may be printed on items. The table also defines fields 302, 304, 306, 308, 310 for each entry. The fields specify: an item identifier 302, an item description 304, an item code identifier 306, item code information 308, and supplemental information 310. The information in the item code printing database 300 may be created and updated, for example, by a manufacturer or merchant.

The item identifier 302 may be, for example, an alphanumeric code associated with a particular item or a type of item. The item description 304 describes the item. The item description may indicate, for example, that the item is a magazine, a software medium (e.g., a compact disc), or a package to be delivered.

The item code identifier 306 may be, for example, an alphanumeric code associated with a particular item code or with a type of item code. The item code information 308 represents the information stored in the item code. The item code information 308 may indicate, for example, a UPC code, a license code, or delivery information associated with a package. The supplemental information 310 represents other information associated with the item code. The supplemental information 310 may indicate, for example, that a plurality of item codes are to be printed on an item.

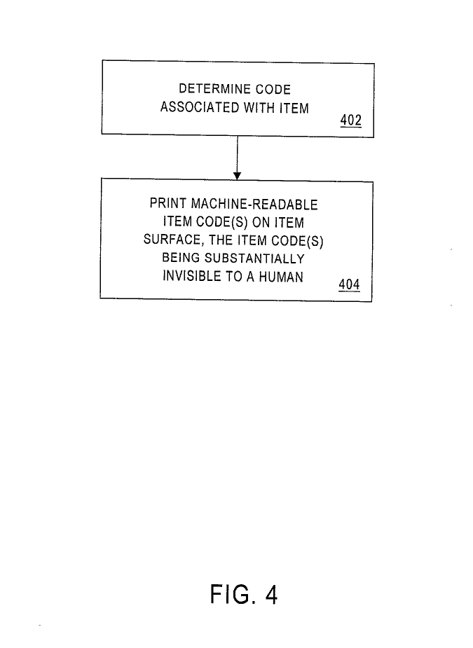

Referring again to FIG. 2, the storage device 230 also stores a program 215 for controlling the processor 210. The processor 210 performs instructions of the program 215, and thereby operates in accordance with the present invention. For example, the processor 210 may perform the method shown in FIG. 4. The flow charts in FIG. 4 and the other figures described herein do not imply a fixed order to the steps, and embodiments of the present invention can be practiced in any order that is practicable. Moreover, the methods may be performed by any of the devices described herein.

At 402, an item code associated with an item is determined. For example, the printing controller 200 may retrieve item code information 308 and supplemental information 310 from the item code printing database 300 based on an item identifier 302.

At 404, a machine-readable item code or codes are printed on an item's surface, at least one of the item codes being substantially invisible to a human. For example, the printing controller 200 may transmit information to the printing device 240 to arrange for two item codes to be printed on the item 100.

Referring again to FIG. 2, the processor 210 is also coupled to a communication device 220 adapted to communicate via a communication network 260, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a cable television network, or an Internet Protocol (IP) network such as the Internet, an intranet or an extranet. Moreover, as used herein, communications include those enabled by wired or wireless technology.

The printing controller 200 may communicate with an input device 270 to receive information associated with item codes (e.g., to receive information from a merchant or a user to be stored on an item via an item code). The input device 270 may comprise, for example, a keyboard, a mouse or other pointing device, a microphone, a knob or a switch (including an electronic representation of a knob or a switch), an infrared port, a docking station, and/or a touch screen. Such an input device 270 may also be incorporated within the printing controller 200.

In one embodiment, the printing controller 200 communicates with a remote item code system 280. The item code system 280 may comprise, for example, a Point Of Sale (POS) system, an inventory system, a delivery service system, an identification system, a warehousing system, a smart shopping cart system, a production system, or an assembly system.

By way of example, the item code system 280 may be associated with a bank that issues credit cards. In this case, the bank may transmit information associated with a credit card account to the printing controller 200 (e.g., information indicating a Social Security number and an expiration date associated with the credit card account). Based on this information, the printing controller 200 may then generate one or more item codes to be printed on a credit card.

Item Code Detecting System

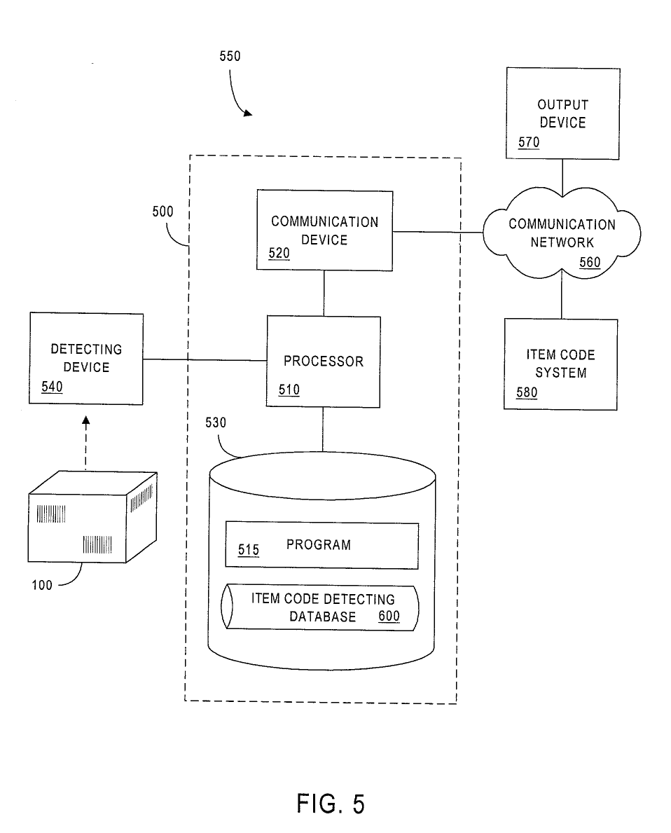

FIG. 5 is a block diagram overview of an item code detecting system 550 according to an embodiment of the present invention. The item code detecting system 550 includes a detecting controller 500 in communication with a detecting device 540 adapted to read machine-readable item codes from an item 100. Although a single detecting controller 500 and detecting device 540 are shown in FIG. 5, any number of these devices may be included in the item code detecting system 550.

The detecting controller 500 comprises a processor 510, such as one or more INTEL® Pentium® processors, coupled to a storage device 530. The storage device 530 may comprise any appropriate information storage device, including combinations of magnetic storage devices, optical storage devices, and/or semiconductor memory devices such as RAM devices and ROM devices.

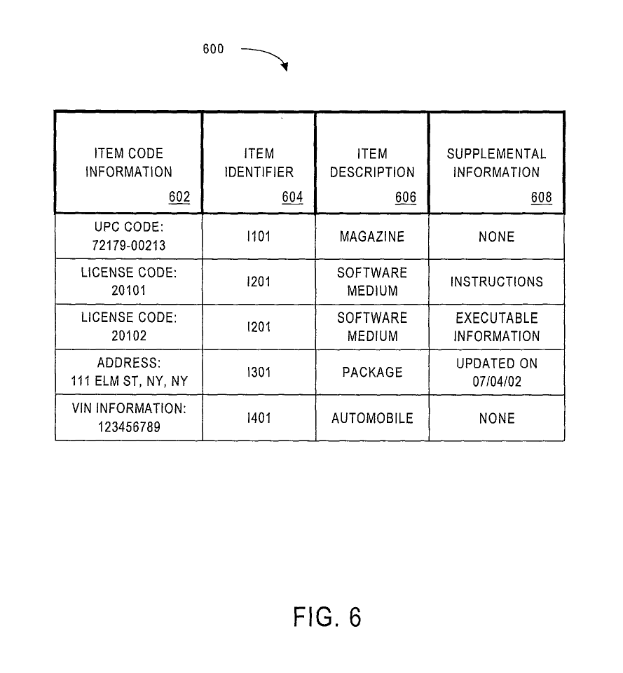

The storage device 530 stores an item code detecting database 600. An example of an item code detecting database 600 will now be described in detail with respect to FIG. 6. A table representing the item code detecting database 600 includes entries identifying item codes that may be read from items. The table also defines fields 602, 604, 606, 608 for each entry. The fields specify: item code information 602, an item identifier 604, an item description 606, and supplemental information 608.

The item code information 602 represents information determined based on an item code. The item code information 602 may indicate, for example, that the item code stores a UPC code, a license code, or delivery information associated with a package. The item identifier 604 may be, for example, an alphanumeric code associated with a particular item or with a type of item. The item description 606 describes the item, and the supplemental information 608 represents other information associated with the item code.

Note that the item identifier 604, the item description 606, and/or the supplemental information 608 may be determined directly from the item code (e.g., the item identifier 604 may be part of the information stored in the item code) or may be retrieved from another database in accordance with the item code information 602.

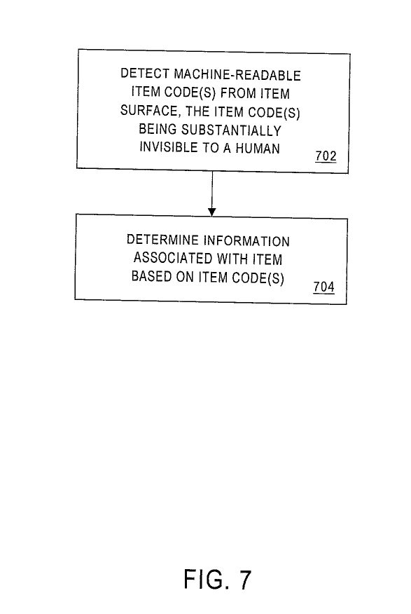

Referring again to FIG. 5, the storage device 530 also stores a program 515 for controlling the processor 510. The processor 510 performs instructions of the program 515, and thereby operates in accordance with the present invention. For example, the processor 510 may perform the method shown in FIG. 7.

At 702, a machine-readable item code or codes are detected and read from an item's surface, at least one of the item code or codes being substantially invisible to a human. For example, the detecting controller 500 may receive information from the detecting device 540 associated with item codes that are printed on an item 100.

At 704, information associated with the item is determined based on the item code or codes. For example, the detecting controller 500 may retrieve supplemental information 608 from the item code detecting database 600 in accordance with item code information 602 received from the detecting device 540.

Referring again to FIG. 5, the processor 510 is also coupled to a communication device 520 adapted to communicate via a communication network 560, such as a LAN, a MAN, a WAN, a proprietary network, a PSTN, a WAP network, a Bluetooth network, a cable television network, or an IP network such as the Internet, an intranet or an extranet.

The detecting controller 500 may communicate with an output device 570 to provide information associated with item codes (e.g., to display information to a consumer, a merchant, or an employee of a delivery service). The output device 570 may comprise, for example, a display (e.g., a computer monitor), a speaker, and/or a printer. Such an output device 570 may also be incorporated within in the detecting controller 500.

In one embodiment, the detecting controller 500 communicates with a remote item code system 580. The item code system 580 may comprise, for example, a POS system, an inventory system, a delivery service system, an identification system, a warehousing system, a smart shopping cart system, a production system, or an assembly system.

By way of example, the item code system 580 may be associated with a merchant's inventory system. In this case, the detecting controller 500 may transmit information associated with item codes to the inventory system when, for example, employees “scan” items (and associated item codes) upon entering or leaving a stocking point. Such an inventory system may then automatically generate notifications to re-order inventory based on a pre-determined inventory stocking policy. For example, the notification may simply warn a merchant that supplies are low or actually order items from a supplier. Such an inventory system may similarly receive information from the detecting controller 500 when a customer removes an item from a shelf (e.g., after he or she scans the item via a portable device attached to a shopping cart) or purchases an item at a POS terminal.

Identification Card Embodiment

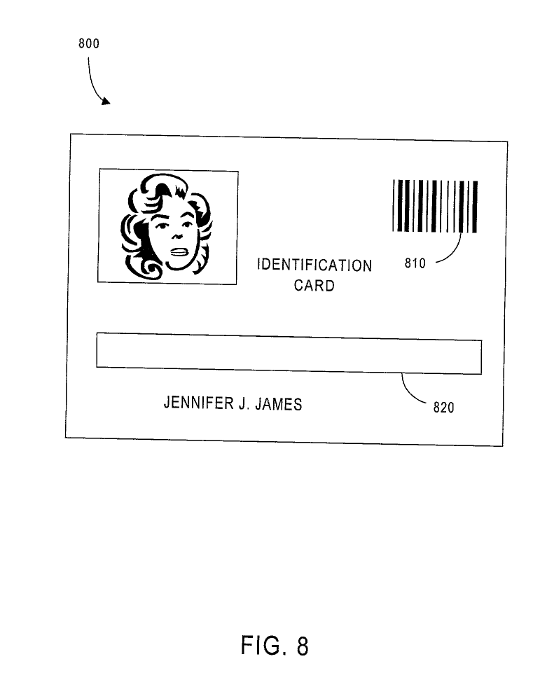

FIG. 8 illustrates an identification card 800 associated with a card-holder according to an embodiment of the present invention. As shown in FIG. 8, the identification card 800 has a machine-readable code 810 printed on the identification card's surface. The identification card 800 may be, for example, a bank card, a credit card, a smart card, a governmental clearance badge, or a student identification card. The identification card 800 may also identify an individual entitled to a particular good or service, as may be the case for an event or transportation ticket (e.g., an airline, bus, or subway ticket). The identification card 800 may also be a promotional coupon entitling a card-holder to a free or discounted good or service (e.g., a 20% discount on a purchase of a computer or a free meal at a restaurant).

According to this embodiment, the code 810 is associated with the card-holder. For example, the code 810 may represent a card-holder identifier or name, an account or other identification number (e.g., a Social Security number), a benefit, or an expiration date (e.g., a date after which the card-holder is no longer authorized to enter a building).

The code 810 is also substantially invisible to a human (the item code 810 is visible in FIG. 8 only to facilitate understanding of the invention). For example, the code 810 may be rendered substantially invisible by forming it with a chemical, an invisible ink, an ink that becomes visible in ultra-violet light, and/or an ink detectable with radiation outside of the visible spectrum.

Although a single code 810 is shown in FIG. 8, any number of item codes may be printed on the identification card 800. For example, item codes may be printed on both the front and back side of the identification card 800. Moreover, it is possible to provide visible information (e.g., a photograph of the card-holder) on the same area of the card's surface as the code 810 if desired.

Note that the identification card 800 may include other machine-readable information in addition to the code 810. For example, a magnetic strip 820 may be affixed to the card to store information associated with the card-holder (e.g., a credit card account number).

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although some embodiments of the present invention are directed to a machine-readable code printed on a surface of an item or an identification card, according to another embodiment the code is instead printed beneath the surface. For example, a chemical code implanted within an identification badge may still be detectable by an appropriate detecting device.

According to another embodiment, a printing controller 200 or a detecting controller 500 exchanges information associated with a batch of item codes. For example, a merchant's POS system may store information collected during business hours and transmit that information to the merchant's inventory system in the evening.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. An item, comprising:
an item surface; and
a plurality of machine-readable item codes printed on the item surface, at least one of the item codes being associated with the item and being substantially invisible to a human.

2. The item of claim 1, wherein each of the item codes are associated with the item and are substantially invisible to a human.

3. The item of claim 1, wherein at least two of the item codes contain the same information.

4. The item of claim 1, wherein at least two of the item codes contain different information.

5. The item of claim 4, wherein the different information is adapted to be combined via at least one of: (i) a sequence number in each item code; (ii) at least one item code describing an order in which at least one other item code should be combined, and (iii) a position of the item codes on the item surface.

6. The item of claim 4, wherein at least one item code contains meta-data associated with at least one other item code.

7. The method of claim 4, wherein the at least two of the item codes containing different information are printed on the item surface via different techniques to render the item codes substantially invisible to a human.

8. The item of claim 1, wherein at least one item code comprises: (i) a bar code, (ii) a two-dimensional code, and (iii) a watermark.

9. The item of claim 1, wherein at least one item code indicates at least one of: (i) an item identifier, (ii) a manufacturer identifier, (iii) a distributor identifier, (iv) a delivery service identifier, (v) a purchaser identifier, (vi) an owner identifier, (vii) a user identifier, and (viii) a merchant identifier.

10. The item of claim 1, wherein at least one item code is adapted for use with at least one of: (i) a point of sale system, (ii) an inventory system, (iii) a delivery service system, (iv) an identification system, (v) a warehousing system, (vi) a smart shopping cart system, (vii) a production system, and (viii) an assembly system.

11. The item of claim 1, wherein at least one item code is formed using at least one of: (i) a chemical, (ii) an invisible ink, (iii) an ink that becomes visible in ultra-violet light, and (iv) an ink detectable with radiation outside of the visible spectrum.

12. The item of claim 1, wherein the item comprises at least one of: (i) a product, (ii) an identification card, (iii) a negotiable instrument, (iv) a container, (v) a package, (vi) an envelope, (vii) an event ticket, and (viii) a document.

13. The item of claim 1, wherein the item surface comprises at least one of: (i) a product surface, (ii) a product label, (iii) a product tag, (iv) a picture, (v) an image, (vi) a container surface, (vii) a package surface, (viii) a container label, (ix) a package label, (x) a container tag, and (xi) a package tag.

14. The item of claim 1, wherein the item has two distinct item surface areas, and at least one item code is printed each distinct item surface area.

15. The item of claim 1, wherein visible information is displayed on the same area of the item surface as at least one item code.

16. An identification card associated with a card-holder, comprising:
an identification card surface; and
a machine-readable code printed on the identification card surface, the code being associated with the card-holder and being substantially invisible to a human.

17. The identification card of claim 16, wherein the code indicates at least one of: (i) a card-holder identifier, (ii) a benefit, and (iii) an expiration date.

18. The identification card of claim 16, wherein visible information is displayed on the same area of the identification card as the code.

19. The identification card of claim 15, wherein a plurality of codes are printed on the identification card surface, each of the codes being associated with the card-holder and being substantially invisible to a human.

20. An item, comprising:
an item surface; and
a machine-readable item code printed on the item surface, the item code being associated with the item and being substantially invisible to a human, wherein the item code is updated by a user.

21. The item of claim 20, wherein the item code is updated by the user to indicate information associated with at least one of: (i) a delivery service, (ii) a location, (iii) a time, (iv) a date, (v) a price, (vi) a merchant, (vii) a purchaser, (viii) an item status, (ix) a warranty, (x) a product, (xi) logistics, (xii) a tax, (xiii) a fee, (xiv) a duty, (xv) an inspection, (xvi) a packing slip, (xvii) a picking slip, (xviii) a bill, (xix) an order status, (xx) a product expiration, (xxi) a repair history, (xxii) a maintenance history, (xxiii) a warranty, and (xxiv) a provenance.

22. The item of claim 20, wherein a plurality of item codes are printed on the item surface, at least one of the item codes being associated with the item and being substantially invisible to a human.

23. An item, comprising:
an item surface; and
a machine-readable item code printed on the item surface, the item code being substantially invisible to a human and indicating at least one of: (i) information associated with use of the item, (ii) information associated with consumption of the item, (iii) instructions associated with the item, (iv) executable information associated with the item, (v) updates to adjust executable information associated with the item, (vi) instructions associated with assembling of the item, (vii) instructions associated with processing the item, (viii) marketing information, (ix) provenance information, (x) information associated with a sale of the item, (xi) information associated with future disposition of the item, (xii) information associated with disposal of the item, (xiii) information associated with reclaiming at least a portion of the item, and (xiv) information associated with recycling at least a portion of the item.

24. The item of claim 23, wherein a plurality of item codes are printed on the item surface.

25. A method of marking an item having an item surface, comprising:
determining an item code associated with the item; and
printing a plurality of machine-readable item codes on the item surface, at least one of the item codes being associated with the item and being substantially invisible to a human.

26. An apparatus for marking an item, comprising:
a printing controller; and
a printing device in communication with the printing controller and adapted to print a plurality of machine-readable item codes on the item surface, at least one of the item codes being associated with the item and being substantially invisible to a human.

27. An apparatus for determining information associated with an item, comprising:
a detection controller; and
a detecting device in communication with the detection controller and adapted to read at least one of a plurality of machine-readable item codes on the item surface, at least one of the item codes being associated with the item and being substantially invisible to a human.

28. The method of claim 27, wherein the detection controller is associated with at least one of: (i) a point of sale system, (ii) an inventory system, (iii) a delivery service system, (iv) an identification system, (v) a warehousing system, (vi) a smart shopping cart system, (vii) a production system, and (viii) an assembly system.
